(19) United States
(12) Patent Application Publication
(10) Pub. No.: US 2026/0196373 A1
(43) Pub. Date: Jul. 9, 2026

(54) INTEGRATED SPHERICAL SEMICONDUCTOR WITH ENHANCED ENERGY CONVERSION VIA QUANTUM EFFECTS FOR STACKED NUCLEAR VOLTAIC POWER SYSTEMS

(71) Applicants: Nima Golsharifi, London (GB); Mohamed Abdelbaset Ahmed, Florence (IT)

(72) Inventors: Nima Golsharifi, London (GB); Mohamed Abdelbaset Ahmed, Florence (IT)

(21) Appl. No.: 19/557,532

(22) Filed: Mar. 5, 2026

(51) Int. Cl. G21H 1/06; G21H 1/04; G21H 1/12

(52) U.S. Cl. CPC G21H 1/06; G21H 1/04; G21H 1/12

(57) ABSTRACT

A nuclear voltaic power cell utilizing spherical semiconductor structures engineered to exploit quantum mechanical effects for enhanced energy conversion from radioactive decay. The invention comprises two primary configurations: (1) a dual-sphere configuration with a smaller inner sphere enclosed by a larger outer sphere, the intervening space filled with gaseous or aerosolized radioactive material, and (2) a multi-layered spherical configuration with concentric semiconductor shells interspersed with radioactive material. Both configurations employ microcrystal wide bandgap semiconductors with grain sizes of 1-100 nm to exploit quantum confinement effects (QCE), quantum-confined Stark effect (QCSE), Lamb shift, Casimir effect, and Purcell effect. The spherical geometry maximizes radiation solid angle capture while the quantum effects optimize charge carrier generation, separation, and collection. Suitable semiconductor materials include diamond, SiC, GaN, and AlN.

### CROSS-REFERENCE TO RELATED APPLICATIONS

This application claims the benefit of priority to Singapore patent application Ser. No. 10202500617Q, filed on Mar. 11, 2025, entitled “Nuclear Voltaic System,” the entire contents of which are incorporated herein by reference.

### FIELD OF THE INVENTION

The present invention relates generally to nuclear voltaic power cells and, more particularly, to spherical semiconductor structures engineered to exploit quantum mechanical effects for enhanced energy conversion from radioactive decay into electrical energy.

The invention pertains specifically to dual-sphere and multi-layered spherical configurations of microcrystal wide bandgap semiconductor materials that utilize quantum confinement effects (QCE), the quantum-confined Stark effect (QCSE), Lamb shift, Casimir effect, and Purcell effect to optimize the generation, separation, and collection of charge carriers.

### BACKGROUND OF THE INVENTION

Nuclear voltaic cells convert energy from radioactive decay into electrical energy. Unlike chemical batteries with limited lifespans, nuclear voltaic cells can operate for decades or centuries depending on the half-life of the radioisotope employed. This makes them attractive for applications requiring long-duration, maintenance-free power sources, including space exploration, deep-sea instrumentation, medical implants, remote sensing, and military applications.

Existing nuclear voltaic cells, however, suffer from several fundamental limitations. Conventional betavoltaic and alphavoltaic devices typically employ planar semiconductor geometries, which capture radiation from only a limited solid angle. This results in significant energy loss as radiation escapes the conversion region without interaction with the semiconductor material. Theoretical analyses have shown that spherical geometries can substantially improve radiation capture efficiency by surrounding the source material with the converting medium.

Furthermore, existing nuclear voltaic cells rely on bulk semiconductor properties for energy conversion. Bulk semiconductors have fixed bandgap energies determined by their crystal structure, limiting the optimization of charge carrier generation and collection. The quantum mechanical effects that arise in nanostructured and microcrystalline semiconductors—including quantum confinement, Stark effect modulation, Lamb shift, Casimir effect, and Purcell effect—have not been systematically exploited in nuclear voltaic device design.

Additionally, prior art devices typically employ solid radioisotope sources in direct contact with or deposited on semiconductor surfaces. This approach limits the surface area of interaction and introduces self-absorption losses within the radioisotope layer, where a significant fraction of the decay energy is absorbed within the radioisotope material itself before reaching the semiconductor.

What is needed is a nuclear voltaic power cell architecture that (1) maximizes radiation capture through geometric optimization, (2) exploits quantum mechanical effects in the semiconductor material to enhance energy conversion efficiency, and (3) enables intimate mixing of the radioisotope material with the conversion medium to minimize self-absorption losses.

### SUMMARY OF THE INVENTION

The present invention addresses the foregoing limitations by providing a nuclear voltaic power cell that utilizes spherical semiconductor structures engineered to exploit multiple quantum mechanical effects for enhanced energy conversion. The invention comprises two primary configurations:

In a first configuration (Dual-Sphere Configuration), a smaller inner semiconductor sphere is enclosed by a larger outer semiconductor sphere. The intervening space between the inner and outer spheres is filled with a gaseous or aerosolized radioactive material. Both spheres comprise multiple layers of microcrystal semiconductor materials engineered to form p-n junctions. The spherical geometry provides near-complete solid angle coverage of the radioisotope material, while the microcrystal semiconductor structure enables exploitation of quantum confinement effects (QCE), the quantum-confined Stark effect (QCSE), and Lamb shift to enhance charge carrier generation and separation.

In a second configuration (Multi-Layered Spherical Configuration), multiple concentric spherical layers of semiconductor materials are stacked to form a single spherical cell. Each concentric layer is designed to form a p-n junction. The gaps between these concentric layers are infused with radioactive material. This configuration exploits all five quantum effects—QCE, QCSE, Lamb shift, Casimir effect, and Purcell effect—to optimize energy states and enhance overall conversion efficiency. The Casimir effect is engineered through precise control of inter-layer spacing, while the Purcell effect is exploited through the resonant cavity characteristics of the spherical geometry.

Both configurations achieve substantially higher energy conversion efficiency compared to conventional planar nuclear voltaic cells by: (a) maximizing radiation solid angle capture through spherical geometry, (b) engineering the semiconductor microcrystal structure to exploit quantum confinement for increased effective bandgap, (c) utilizing the quantum-confined Stark effect for enhanced charge separation, (d) optimizing energy levels through Lamb shift engineering, (e) enhancing the Lamb shift through Casimir effect engineering of inter-surface spacing, and (f) boosting spontaneous emission rates through Purcell effect in the spherical resonant cavity.

### BRIEF DESCRIPTION OF THE DRAWINGS

FIG. 1 is a cross-sectional view of the dual-sphere nuclear voltaic power cell showing the inner and outer semiconductor spheres with the intervening radioactive material space.

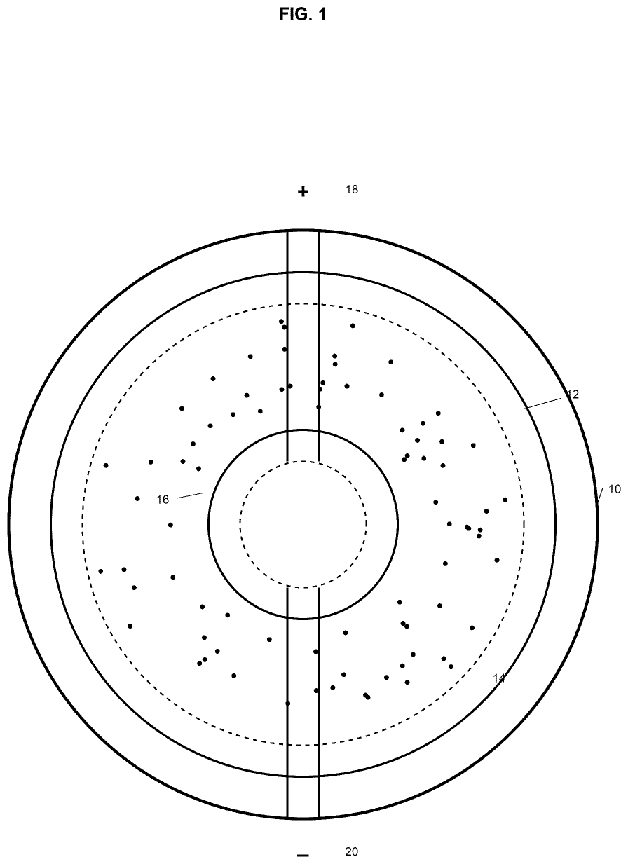

FIG. 2 is a cross-sectional view of the multi-layered spherical nuclear voltaic power cell showing concentric semiconductor layers with interspersed radioactive material.

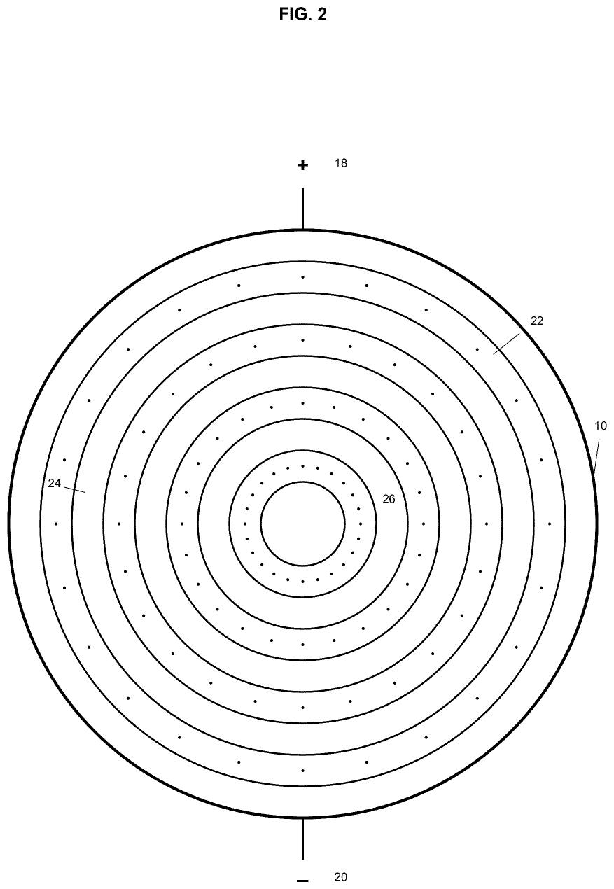

FIG. 3 is a detailed cross-sectional view of the microcrystal semiconductor layer structure showing the p-n junction and grain boundaries.

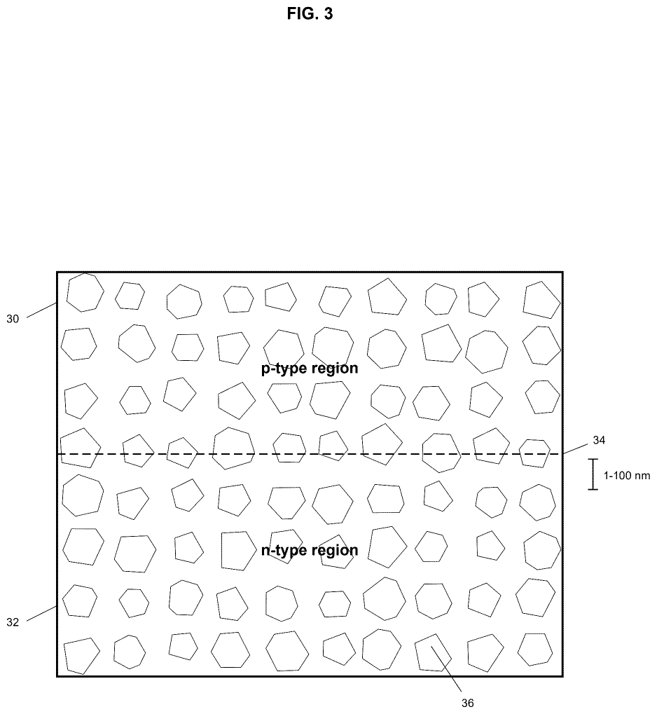

FIG. 4 is an energy band diagram illustrating quantum confinement effects in the microcrystal semiconductor grains, showing the increased effective bandgap and discrete energy levels.

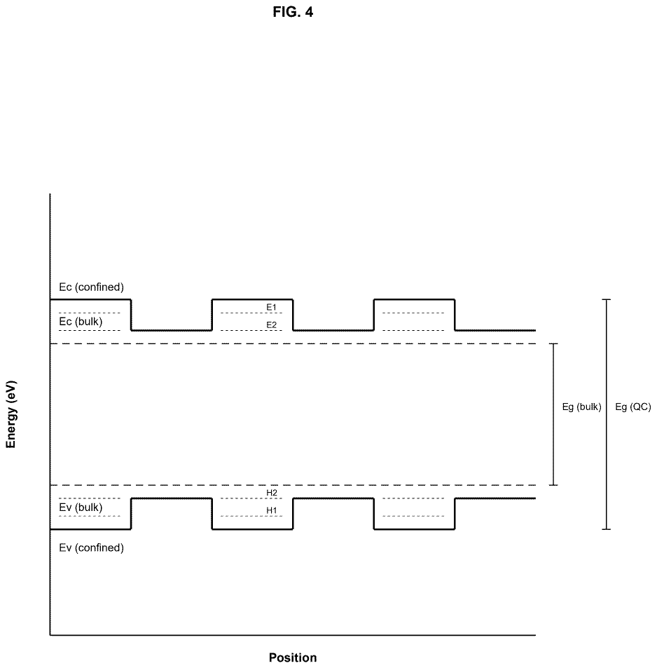

FIG. 5 is an exploded assembly view of the dual-sphere configuration showing all component layers.

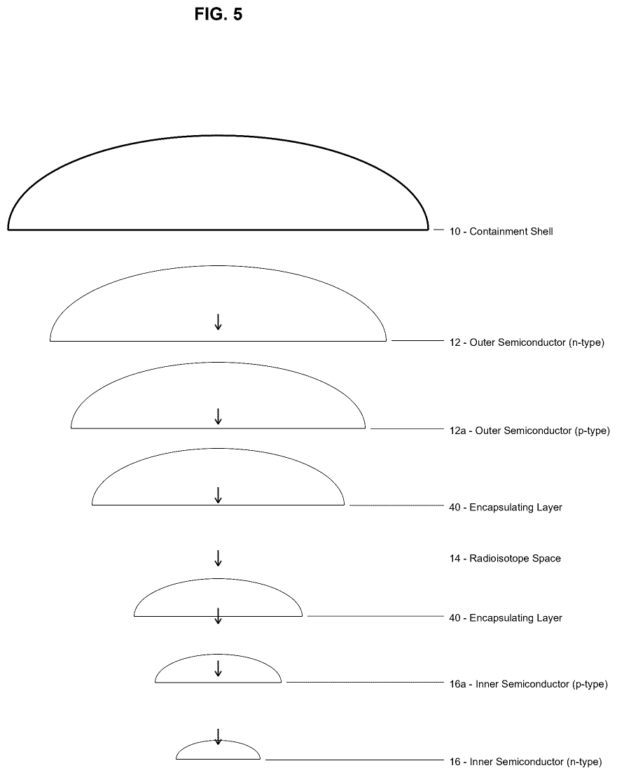

FIG. 6 is an exploded assembly view of the multi-layered spherical configuration showing individual concentric shells.

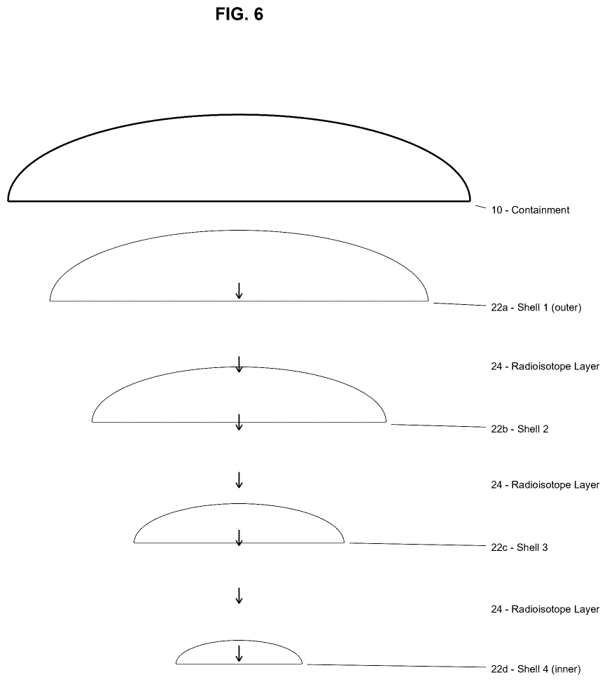

FIG. 7 is a parts identification reference table for all numbered components.

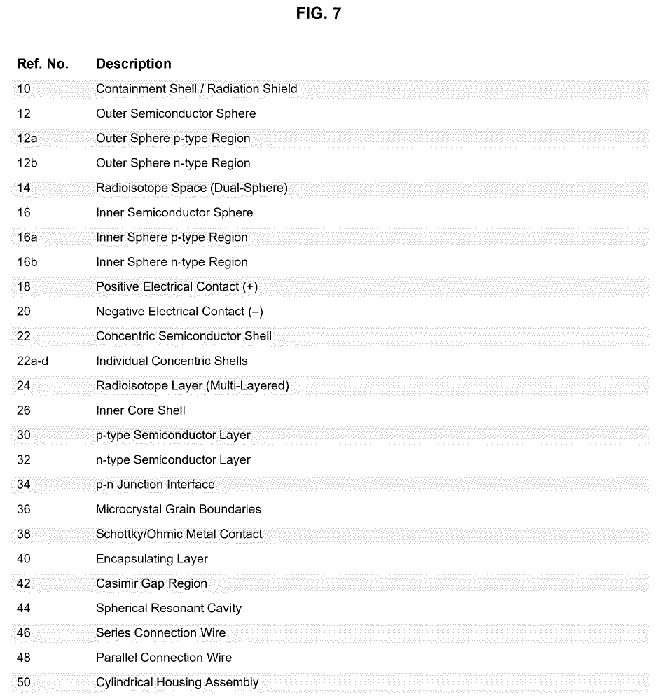

FIG. 8 is a diagram illustrating the Casimir effect between adjacent semiconductor surfaces within the multi-layered configuration.

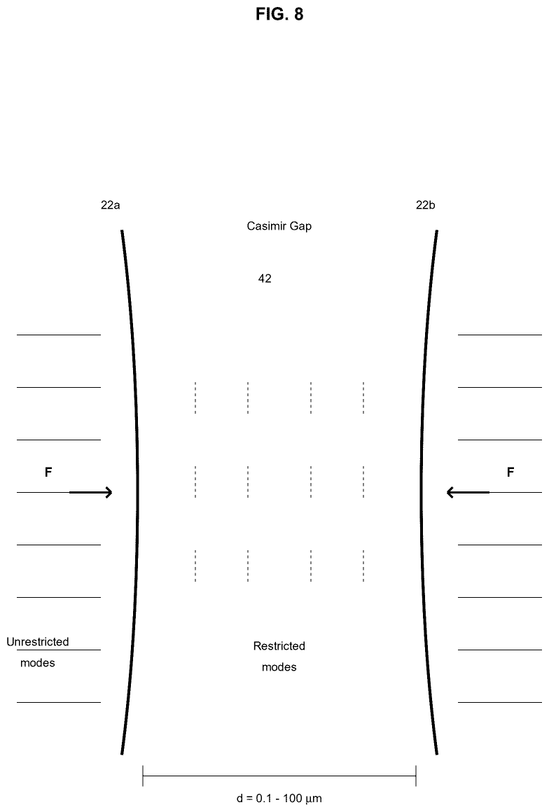

FIG. 9 is a diagram illustrating the Purcell effect enhancement of spontaneous emission within the spherical resonant cavity.

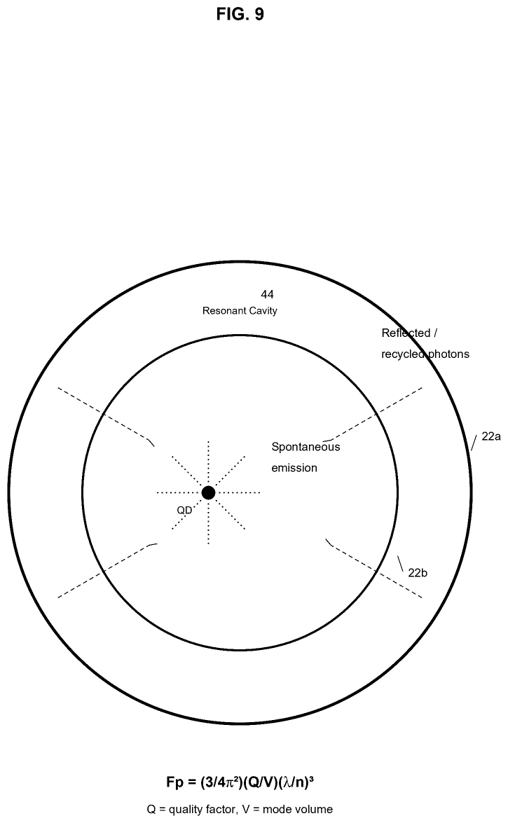

FIG. 10 is a schematic diagram of a series-parallel connection of multiple spherical nuclear voltaic cells for scalable power output.

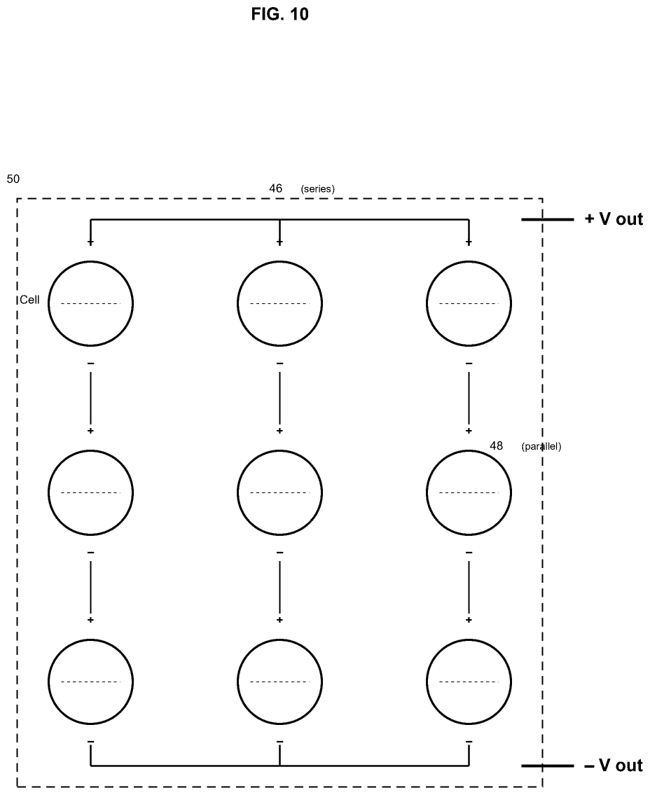

### DETAILED DESCRIPTION OF THE INVENTION

### Concept Overview

The present invention provides a significant advancement in nuclear voltaic power cells by integrating spherical semiconductor structures that utilize advanced quantum mechanical effects observed in microcrystal semiconductor materials to improve energy conversion efficiency. The spherical geometry ensures near-complete capture of radiation emitted by the radioactive material, while the microcrystal semiconductor structure enables exploitation of quantum phenomena that are absent in conventional bulk semiconductor devices.

The dual-sphere and multi-layered spherical configurations offer complementary approaches to maximize energy conversion. The dual-sphere configuration is optimized for gaseous and aerosolized radioisotopes, providing a large-volume interaction region between the inner and outer semiconductor shells. The multi-layered spherical configuration is optimized for solid or liquid radioisotope materials deposited between closely spaced concentric semiconductor shells, enabling Casimir effect and Purcell effect enhancement.

### Quantum Mechanical Effects

### Quantum Confinement Effects (QCE)

In semiconductor structures where charge carriers (electrons and holes) are confined within dimensions comparable to or smaller than the de Broglie wavelength (typically 1-100 nanometers for common semiconductors), quantum confinement effects become significant. The confinement modifies the density of states and increases the effective bandgap of the semiconductor material beyond its bulk value.

In the present invention, the microcrystal semiconductor layers in both the inner and outer spheres (dual-sphere configuration) and in each concentric shell (multi-layered configuration) are engineered with grain sizes in the range of approximately 1 to 100 nanometers to induce quantum confinement. The spherical quantum dot layers used in both configurations maximize this effect, increasing the generation of electron-hole pairs when exposed to the radiation emitted by the radioactive material. Three confinement regimes are distinguished: strong confinement (grain sizes of approximately 1-10 nm), where the bandgap increase is most pronounced and discrete energy levels are clearly resolved; moderate confinement (grain sizes of approximately 10-50 nm), where bandgap enhancement is measurable but the density of states approaches bulk behavior; and weak confinement (grain sizes of approximately 50-100 nm), where quantum effects are subtle but still contribute to improved conversion efficiency.

### Quantum-Confined Stark Effect (QCSE)

The quantum-confined Stark effect (QCSE) describes the modification of energy levels and optical properties of a quantum-confined system in the presence of an external electric field. In the present invention, the interaction between charge carriers and the electric field induced by the radioactive material in the spherical geometries results in a shift of energy levels and an increased lifetime of excitons.

This effect is optimized by carefully selecting the semiconductor material composition and the size of the microcrystal grains. The QCSE enables fine-tuning of the absorption and emission characteristics of the semiconductor layers, ensuring efficient charge separation and collection. In the spherical geometry, the radially symmetric electric field provides uniform QCSE modulation across the entire solid angle, unlike planar devices where the field is unidirectional.

### Lamb Shift Optimization

The Lamb shift is a quantum electrodynamic phenomenon where energy levels of a quantum system shift due to interactions with the quantized electromagnetic field (vacuum fluctuations). In small semiconductor quantum dots and microcrystal grains, this shift is significant and can be tuned by controlling the grain size, the dielectric environment, and the cavity geometry.

The present invention utilizes the Lamb shift to optimize the energy levels within the semiconductor material for better separation and reduced recombination of electron-hole pairs. By engineering the microcrystal grain size and the inter-grain spacing, the Lamb shift is tuned to shift energy levels in a direction that increases the effective barrier to recombination, thereby improving the net charge collection efficiency.

### Casimir Effect Utilization

The Casimir effect arises from the interaction of quantum vacuum fluctuations with conducting or dielectric surfaces in close proximity. When two surfaces are separated by a gap on the order of nanometers to tens of nanometers, the restriction of electromagnetic modes within the gap relative to the unrestricted modes outside creates a measurable force between the surfaces.

In the multi-layered spherical configuration, the spacing between concentric semiconductor shells is engineered in the range of approximately 0.1 to 100 micrometers, with the radioisotope material filling these gaps. Within the microcrystal semiconductor material itself, the inter-grain boundaries provide Casimir-effect-relevant spacings on the order of 1-20 nanometers. The design incorporates aspects of the Casimir effect by engineering the spacing between the layers and the dielectric properties to enhance the Lamb shift's influence, further fine-tuning the energy levels within the device.

### Purcell Effect for Emission Enhancement

The Purcell effect describes the enhancement of the spontaneous emission rate of a quantum system when placed inside a resonant cavity. The enhancement factor (Purcell factor) is proportional to the quality factor (Q) of the cavity and inversely proportional to the mode volume (V).

In the present invention, the spherical geometry of the semiconductor layers is designed to act as a resonant cavity. Each concentric semiconductor shell in the multi-layered configuration forms a spherical cavity that enhances the spontaneous emission rate of electron-hole recombination radiation, which is then reabsorbed by adjacent semiconductor layers, creating a photon recycling mechanism that improves overall conversion efficiency. The dual-sphere configuration similarly exploits the cavity formed between the inner and outer spheres.

### Dual-Sphere Configuration

The dual-sphere configuration comprises a smaller inner semiconductor sphere enclosed by a larger outer semiconductor sphere. The space between the inner and outer spheres is filled with a gaseous or aerosolized radioactive material. This configuration provides the following advantages: (a) near-complete solid angle coverage of the radioisotope material by the semiconductor converter, (b) a large-volume interaction region for gaseous or aerosolized radioisotopes, (c) intimate mixing of the radioisotope with the conversion volume to minimize self-absorption losses, and (d) exploitation of QCE, QCSE, and Lamb shift for enhanced conversion.

The inner sphere comprises multiple layers of microcrystal semiconductor materials engineered to form p-n junctions. The inner sphere has an outer diameter in the range of approximately 1 millimeter to 50 millimeters, depending on the application. The semiconductor layers of the inner sphere are arranged with the p-type region facing outward (toward the radioisotope space) and the n-type region facing inward, creating a built-in electric field that separates electron-hole pairs generated by incident radiation.

The outer sphere similarly comprises multiple layers of microcrystal semiconductor materials forming p-n junctions. The outer sphere has an inner diameter larger than the outer diameter of the inner sphere to define the radioisotope containment space. The semiconductor layers of the outer sphere are arranged with the p-type region facing inward (toward the radioisotope space) and the n-type region facing outward, creating a complementary electric field to that of the inner sphere.

Electrical contacts penetrate the outer containment structure to connect to both the inner and outer spheres. At least one positive electrical contact connects to the p-type region of one or both spheres, and at least one negative electrical contact connects to the n-type region of one or both spheres. The contacts may be cylindrical conductors that extend through the containment structure.

### Multi-Layered Spherical Configuration

The multi-layered spherical configuration comprises multiple concentric spherical layers of semiconductor materials, each designed to form a p-n junction, stacked together to create a single spherical cell. The number of concentric semiconductor shells ranges from approximately 3 to 20, depending on the application requirements.

The gaps between the concentric semiconductor shells are infused with radioactive material in solid, liquid, gaseous, or aerosolized form. The spacing between adjacent shells is in the range of approximately 0.1 to 100 micrometers, optimized based on the type of radiation (alpha, beta, or gamma) and the required exploitation of the Casimir effect.

This configuration exploits all five quantum effects: QCE and QCSE in the microcrystal semiconductor grains, Lamb shift optimization through grain size and dielectric environment engineering, Casimir effect through precise control of inter-shell spacing, and Purcell effect through the resonant cavity characteristics of each concentric shell pair. The closely spaced concentric shells create multiple Casimir cavities, while each shell pair forms a spherical resonant cavity for Purcell enhancement.

### Material Specifications

### Radioisotopes

The system utilizes at least one of the following radioisotopes, either singly or in combination, for generating ionizing radiation, including but not limited to: P-32, V-48, Cf-253, Cr-51, Md-258, Be-7, Cf-254, Co-56, Sc-46, S-35, Tm-168, Fm-257, Tm-170, Po-210, Ca-45, Au-195, Zn-65, Co-57, V-49, Cf-248, Ru-106, Np-235, Cd-109, Tm-171, Cs-134, Na-22, Fe-55, Rh-101, Co-60, Kr-85, H-3, Cf-250, Nb-93m, Sr-90, Cm-243, Cs-137, Ti-44, U-232, Pu-238, Sm-151, Ni-63, Si-32, Ar-39, Cf-249, Ag-108, Am-241, AmBe, Hg-194, Nb-91, Cf-251, Ho-166m1, Bk-247, Ra-226, Mo-93, Ho-153, Cm-246, C-14, Pu-240, Th-229, Am-243, Cm-244, Cm-245, Cm-250, Nb-94, Pu-239, U-233, U-234, Pu-242, Np-237, U-235, U-236, and U-238.

In preferred embodiments, the radioisotope is selected from the group consisting of Ni-63 (half-life approximately 100 years, beta emitter), Sr-90 (half-life approximately 28.8 years, beta emitter), H-3 (half-life approximately 12.3 years, beta emitter), Am-241 (half-life approximately 432 years, alpha emitter), and Pu-238 (half-life approximately 87.7 years, alpha emitter). The selection of radioisotope depends on the intended application, required power density, operational lifetime, and regulatory considerations.

In the dual-sphere configuration, the radioisotope is provided in gaseous or aerosolized form to fill the space between the inner and outer spheres. In the multi-layered spherical configuration, the radioisotope may be provided in solid, liquid, gaseous, or aerosolized form to fill the gaps between concentric semiconductor shells.

### Semiconductor Materials

The semiconductor converter layers in both the inner and outer spheres (dual-sphere configuration) and in each concentric shell (multi-layered configuration) utilize microcrystal wide bandgap semiconductor materials. The microcrystal grain sizes are engineered in the range of approximately 1 to 100 nanometers to exploit quantum confinement effects. The system utilizes at least one of the following semiconductor materials, including but not limited to:

| Semiconductor Material | Bandgap (eV) |
|---|---|
| Silicon Carbide (SiC) | 3.26 |
| Zinc Oxide (ZnO) | 3.37 |
| Gallium Nitride (GaN) | 3.4 |
| Gallium Oxide (Ga2O3) | 4.8 |
| Diamond | 5.5 |
| Boron Nitride (BN) | 5.8 |
| Aluminum Nitride (AlN) | 6.2 |

In preferred embodiments, diamond (bandgap 5.5 eV) or silicon carbide (SiC, bandgap 3.26 eV) is used as the primary semiconductor material due to their high radiation hardness, wide bandgap, and favorable electronic properties for nuclear voltaic applications. The semiconductor layers are deposited using techniques including but not limited to chemical vapor deposition (CVD), physical vapor deposition (PVD), molecular beam epitaxy (MBE), atomic layer deposition (ALD), sol-gel processing, and hydrothermal synthesis.

### Electrical Contacts

### Schottky Diode Contacts

Schottky contacts form a metal-semiconductor junction characterized by a low forward voltage drop and fast switching. The metals used are selected based on their work function, which influences the barrier height and efficiency of the diode. The system may utilize at least one of the following Schottky contact materials:

| Metal | Work Function (eV) |
|---|---|
| Aluminum (Al) | 4.28 |
| Titanium (Ti) | 4.33 |
| Gold (Au) | 5.1 |
| Nickel (Ni) | 5.15 |
| Palladium (Pd) | 5.6 |
| Platinum (Pt) | 5.65 |

### Ohmic Contacts

Ohmic contacts ensure minimal resistance at the metal-semiconductor interface, providing a linear I-V characteristic and efficient charge injection. The system may utilize at least one of the following ohmic contact materials:

| Metal | Specific Contact Resistance (Ω · cm²) |
|---|---|
| Gold (Au) | 10\hat{ }−6 to 10\hat{ }−5 |
| Silver (Ag) | 10\hat{ }−7 to 10\hat{ }−6 |
| Aluminum (Al) | 10\hat{ }−6 to 10\hat{ }−5 |
| Titanium (Ti) | 10\hat{ }−5 to 10\hat{ }−4 |
| Nickel (Ni) | 10\hat{ }−5 to 10\hat{ }−4 |
| Copper (Cu) | 10\hat{ }−6 to 10\hat{ }−5 |

### Other Electrical Contacts

For specialized applications such as transparent contacts or high-temperature environments, the system may additionally utilize Indium Tin Oxide (ITO), Graphene, Molybdenum (Mo), Tungsten (W), or Chromium (Cr).

### Containment and Radiation Shielding

The system utilizes at least one radiation shield that encompasses or contains the radioisotopes, the semiconductor converter spheres, and the electrical contacts. The containment structure is crucial for maintaining the integrity and safety of the nuclear voltaic power source. The materials used must possess high mechanical strength, radiation resistance, and compatibility with the semiconductor converter and radioisotope materials.

| | Tensile | Density |
|---|---|---|
| Material | Strength (MPa) | (g/cm³) |
| Inconel 617 | 769 | 8.19 |
| SIFSIX-3-Cu | 70 | 1.168 |
| Ni-MOF-74 | 70 | 1.174 |
| MOF-505 | 90 | 1.172 |
| Stainless Steel 304 | 515-625 | 7.93 |
| Stainless Steel 316 | 579 | 8 |
| GH3535 | 308-360 | 8.05 |
| Silicon | 48-97 | 2.329 |
| Glass (Annealed) | 32-78 | 2.5 |
| Glass (Heat-Strengthened) | 70-140 | 2.5 |

The containment structure for the dual-sphere configuration is designed as a spherical shell that surrounds the outer semiconductor sphere. The containment provides radiation shielding sufficient to reduce external radiation levels to safe limits per applicable regulations (e.g., 10 CFR Part 20 in the United States).

### Encapsulating Layer

An encapsulating layer surrounds each semiconductor sphere or shell to provide mechanical protection, environmental isolation, and prevention of radioactive material migration. The encapsulating layer may comprise ultra-thin glass, polymer, ceramic, or metallic coatings with a thickness in the range of approximately 0.1 to 10 micrometers.

In the dual-sphere configuration, the encapsulating layer coats the exterior of the inner sphere and the interior of the outer sphere to prevent direct contact between the gaseous or aerosolized radioisotope and the semiconductor surfaces while remaining sufficiently thin to allow radiation to pass through with minimal attenuation.

### Principles of Operation

In operation, the radioactive material undergoes spontaneous decay, emitting ionizing radiation (alpha particles, beta particles, and/or gamma rays depending on the isotope). In the dual-sphere configuration, radiation emitted from the gaseous or aerosolized radioisotope in the inter-sphere space travels outward to the outer sphere and inward to the inner sphere, providing near-complete utilization of the emitted radiation.

When the radiation interacts with the microcrystal semiconductor layers, it generates electron-hole pairs. The quantum confinement effects in the microcrystal grains increase the effective bandgap, allowing the generated charge carriers to have higher energy than in bulk semiconductors. The QCSE, enhanced by the radially symmetric electric field in the spherical geometry, increases the lifetime of the generated excitons, providing more time for charge separation.

The built-in electric field of the p-n junction separates the electrons and holes, directing them to the respective electrical contacts. The Lamb shift, tuned through grain size engineering and enhanced by the Casimir effect between closely spaced surfaces, optimizes the energy levels to minimize recombination losses. In the multi-layered configuration, the Purcell effect in the spherical resonant cavities enhances photon recycling between adjacent shells, further improving overall efficiency.

### Applications

The nuclear voltaic power cells of the present invention are suitable for a wide range of applications, including but not limited to: (a) space exploration power sources for satellites, deep-space probes, and planetary rovers requiring decades of continuous power; (b) medical implant power sources for cardiac pacemakers, neurostimulators, and drug delivery systems; (c) military and defense applications including remote sensor networks, unmanned systems, and secure communication devices; (d) deep-sea and extreme environment instrumentation; (e) Internet of Things (IoT) sensor nodes requiring maintenance-free long-duration power; (f) emergency and disaster response infrastructure; and (g) nuclear-powered batteries in standard form factors (e.g., 2170 cylindrical cells) for consumer and industrial applications.

### Specific Embodiments

In a first preferred embodiment, a dual-sphere nuclear voltaic cell comprises an inner sphere of SiC microcrystal semiconductor (grain size approximately 5-20 nm) with an outer diameter of 10 mm, an outer sphere of SiC microcrystal semiconductor with an inner diameter of 15 mm, the inter-sphere space filled with Kr-85 gas at approximately 1 atmosphere, Schottky contacts of palladium (Pd), ohmic contacts of gold (Au), and an Inconel 617 containment shell. This embodiment is optimized for long-duration low-power applications such as IoT sensors.

In a second preferred embodiment, a multi-layered spherical nuclear voltaic cell comprises 8 concentric shells of diamond microcrystal semiconductor (grain size approximately 3-15 nm), with inter-shell gaps of approximately 5-50 micrometers filled with solid Ni-63 radioisotope, platinum (Pt) Schottky contacts, silver (Ag) ohmic contacts, and a stainless steel 316 containment shell. This embodiment is optimized for high-power-density applications such as medical implants.

In a third preferred embodiment, a dual-sphere nuclear voltaic cell comprises inner and outer spheres of GaN microcrystal semiconductor (grain size approximately 10-30 nm), the inter-sphere space filled with aerosolized Am-241, titanium (Ti) Schottky contacts, aluminum (Al) ohmic contacts, and a GH3535 containment shell. This embodiment is optimized for high-energy alpha-emitter applications such as space power systems.

### Fabrication Methods

The microcrystal semiconductor spheres and shells are fabricated using techniques that provide control over grain size in the quantum confinement regime (1-100 nm). Suitable fabrication methods include: (a) chemical vapor deposition (CVD) on spherical substrates, with growth conditions tuned to produce microcrystalline rather than single-crystal films; (b) physical vapor deposition (PVD) including sputtering and electron beam evaporation; (c) atomic layer deposition (ALD) for precise thickness control of individual layers; (d) sol-gel processing for oxide semiconductor materials (ZnO, Ga2O3); (e) hydrothermal synthesis for certain material systems; and (f) molecular beam epitaxy (MBE) for the highest quality epitaxial layers.

The p-type and n-type doping of the semiconductor layers is achieved through conventional dopant incorporation techniques adapted for the microcrystal growth regime. For SiC, nitrogen doping provides n-type conductivity and aluminum doping provides p-type conductivity. For GaN, silicon doping provides n-type and magnesium doping provides p-type conductivity. For diamond, boron doping provides p-type and phosphorus or nitrogen doping provides n-type conductivity.

Assembly of the dual-sphere configuration involves: (a) fabricating the inner semiconductor sphere on a sacrificial or permanent spherical substrate, (b) applying the encapsulating layer, (c) positioning the inner sphere within the outer sphere shell, (d) installing electrical contacts, (e) enclosing the assembly within the containment structure, and (f) introducing the gaseous or aerosolized radioisotope through a fill port that is subsequently sealed.

Assembly of the multi-layered spherical configuration involves sequential deposition of alternating semiconductor shells and radioisotope layers, building outward from the innermost shell. Each semiconductor shell is completed with its p-n junction structure and encapsulating layer before the next radioisotope layer and semiconductor shell are deposited.

What is claimed is:

1. A dual-sphere nuclear voltaic power cell comprising:
an inner semiconductor sphere comprising a plurality of microcrystal wide bandgap semiconductor layers forming at least one p-n junction, wherein the microcrystal grains have a size in the range of approximately 1 to 100 nanometers to induce quantum confinement effects;
an outer semiconductor sphere enclosing the inner semiconductor sphere and comprising a plurality of microcrystal wide bandgap semiconductor layers forming at least one p-n junction;
a radioactive material disposed in the space between the inner semiconductor sphere and the outer semiconductor sphere;
at least one positive electrical contact and at least one negative electrical contact for extracting electrical current generated by the interaction of radiation from the radioactive material with the semiconductor layers; and
at least one containment structure encompassing the outer semiconductor sphere and providing radiation shielding.

2. The power cell of claim 1, wherein the wide bandgap semiconductor material is selected from the group consisting of silicon carbide (SiC), zinc oxide (ZnO), gallium nitride (GaN), gallium oxide (Ga2O3), diamond, boron nitride (BN), and aluminum nitride (AlN).

3. The power cell of claim 1, wherein the radioactive material is in gaseous or aerosolized form and fills the space between the inner and outer semiconductor spheres.

4. The power cell of claim 1, wherein the microcrystal semiconductor layers exploit quantum confinement effects (QCE) to increase the effective bandgap beyond the bulk bandgap of the semiconductor material and exploit the quantum-confined Stark effect (QCSE) to enhance charge separation in the presence of the electric field generated by the radioactive material.

5. The power cell of claim 1, wherein the microcrystal grain sizes are engineered to optimize the Lamb shift for reduced electron-hole recombination.

6. The power cell of claim 1, wherein the inner semiconductor sphere has a p-type region facing outward toward the radioactive material and an n-type region facing inward, and the outer semiconductor sphere has a p-type region facing inward toward the radioactive material and an n-type region facing outward.

7. The power cell of claim 1, wherein the electrical contacts comprise at least one Schottky diode contact selected from the group consisting of aluminum (Al), titanium (Ti), gold (Au), nickel (Ni), palladium (Pd), and platinum (Pt), and at least one ohmic contact selected from the group consisting of gold (Au), silver (Ag), aluminum (Al), titanium (Ti), nickel (Ni), and copper (Cu).

8. The power cell of claim 1, further comprising an encapsulating layer disposed on the exterior of the inner semiconductor sphere and on the interior of the outer semiconductor sphere, the encapsulating layer providing mechanical protection and preventing direct contact between the radioactive material and the semiconductor surfaces.

9. The power cell of claim 1, wherein the radioactive material is selected from the group consisting of Ni-63, Sr-90, H-3, Am-241, Pu-238, Kr-85, Cs-137, Co-60, and C-14.

10. The power cell of claim 1, wherein the containment structure is fabricated from a material selected from the group consisting of Inconel 617, stainless steel 304, stainless steel 316, GH3535, SIFSIX-3-Cu, Ni-MOF-74, and MOF-505.

11. The power cell of claim 1, wherein the inner semiconductor sphere has an outer diameter in the range of approximately 1 mm to 50 mm.

12. The power cell of claim 1, wherein the space between the inner and outer semiconductor spheres defines a gap in the range of approximately 1 mm to 25 mm.

13. A multi-layered spherical nuclear voltaic power cell comprising:
a plurality of concentric spherical semiconductor shells, each shell comprising microcrystal wide bandgap semiconductor material forming a p-n junction, wherein the microcrystal grains have a size in the range of approximately 1 to 100 nanometers;
a radioactive material disposed in the gaps between adjacent concentric semiconductor shells;
at least one positive electrical contact and at least one negative electrical contact for extracting electrical current; and
at least one containment structure providing radiation shielding;
wherein the spacing between adjacent concentric semiconductor shells is engineered to exploit the Casimir effect to enhance the Lamb shift of energy levels within the semiconductor material, and wherein the spherical geometry of the semiconductor shells is configured to exploit the Purcell effect for enhanced spontaneous emission rates.

14. The power cell of claim 13, comprising between 3 and 20 concentric semiconductor shells.

15. The power cell of claim 13, wherein the spacing between adjacent concentric semiconductor shells is in the range of approximately 0.1 to 100 micrometers.

16. The power cell of claim 13, wherein the Casimir effect between adjacent semiconductor shell surfaces enhances the observability and impact of the Lamb shift on energy levels within the microcrystal semiconductor grains.

17. The power cell of claim 13, wherein the spherical resonant cavity formed by each pair of adjacent semiconductor shells provides a Purcell enhancement factor proportional to Q/V, where Q is the quality factor of the cavity and V is the mode volume, resulting in enhanced photon recycling between adjacent shells.

18. The power cell of claim 13, wherein the wide bandgap semiconductor material is selected from the group consisting of silicon carbide (SiC), zinc oxide (ZnO), gallium nitride (GaN), gallium oxide (Ga2O3), diamond, boron nitride (BN), and aluminum nitride (AlN).

19. The power cell of claim 13, wherein the radioactive material is in solid, liquid, gaseous, or aerosolized form.

20. The power cell of claim 13, wherein the concentric semiconductor shells exploit all five quantum effects: quantum confinement effects (QCE), quantum-confined Stark effect (QCSE), Lamb shift, Casimir effect, and Purcell effect.

21. A method of generating electrical power from radioactive decay, the method comprising:
providing at least one semiconductor structure in a spherical geometry, the semiconductor structure comprising microcrystal wide bandgap semiconductor material with grain sizes in the range of approximately 1 to 100 nanometers forming at least one p-n junction;
disposing a radioactive material in proximity to the semiconductor structure such that radiation from the radioactive material interacts with the microcrystal semiconductor material;
exploiting quantum confinement effects in the microcrystal semiconductor grains to increase the effective bandgap and enhance electron-hole pair generation; and
collecting the generated electrical current through at least one positive electrical contact and at least one negative electrical contact.

22. The method of claim 21, wherein the semiconductor structure is configured as a dual-sphere arrangement comprising an inner semiconductor sphere and an outer semiconductor sphere with the radioactive material disposed in the space between them in gaseous or aerosolized form.

23. The method of claim 21, wherein the semiconductor structure is configured as a multi-layered spherical arrangement comprising a plurality of concentric semiconductor shells with the radioactive material disposed in the gaps between adjacent shells.

24. The method of claim 23, further comprising engineering the spacing between adjacent concentric semiconductor shells to exploit the Casimir effect to enhance the Lamb shift of energy levels within the semiconductor material.

25. The method of claim 23, further comprising exploiting the Purcell effect in the spherical resonant cavities formed by adjacent semiconductor shells to enhance photon recycling and improve overall conversion efficiency.

26. The method of claim 21, further comprising engineering the microcrystal grain sizes to optimize the quantum-confined Stark effect (QCSE) for enhanced charge separation in the presence of the electric field generated by the radioactive material.

27. The method of claim 21, further comprising engineering the microcrystal grain sizes and dielectric environment to optimize the Lamb shift for reduced electron-hole recombination.

28. A nuclear voltaic power system comprising:
a plurality of spherical nuclear voltaic power cells, each cell comprising at least one semiconductor structure in a spherical geometry having microcrystal wide bandgap semiconductor material with grain sizes in the range of approximately 1 to 100 nanometers forming p-n junctions, and a radioactive material disposed in proximity to the semiconductor structure; and
an interconnection arrangement connecting the plurality of cells in at least one of a series configuration, a parallel configuration, or a combination thereof;
wherein the system provides a combined electrical output determined by the number of cells and the interconnection arrangement.

29. The system of claim 28, wherein the plurality of spherical nuclear voltaic power cells are arranged in a cylindrical assembly compatible with a standard battery form factor.

30. The system of claim 28, wherein each spherical power cell is configured as either a dual-sphere cell or a multi-layered spherical cell.
